(19) United States
(12) Patent Application Publication
(10) Pub. No.: US 2007/0120389 A1
(43) Pub. Date: May 31, 2007

(54) Folding Sunshade for Car Seat

(76) Inventor: Felicia Gallegos Geier, Albuquerque, NM (US)

Correspondence Address: MERCHANT & GOULD PC, P.O. BOX 2903, MINNEAPOLIS, MN, 55402-0903, US

(21) Appl. No.: 11/668,216

(22) Filed: Jan. 29, 2007

Related U.S. Application Data
(63) Continuation-in-part of application No. 10/246,500, filed on Sep. 18, 2002, now Pat. No. 7,091,127.

(51) Int. Cl. B60J 3/00

(52) U.S. Cl. 296/97.1

(57) ABSTRACT

Embodiments of the invention are directed to a sunshade for an infant car seat or similar which is held in position by inserting a rear panel between the car seat and the vehicle seat on which it rests. A top panel, flexibly connected to the rear panel extends forward over the car seat to provide shade. Side panels extend downward from the sides of the top panel to provide increased protection. An optional front flap extends downward from the front edge of the top panel at an adjustable angle to further increase the level of protection. The side panels may be individually folded up and over the top panel to a stored position when not needed. The top and side panels can be folded upward and rearward as a unit to improve access to the car seat. Optional lengthwise creases in the side panels allow them to be folded into a more compact size to decrease the clearance necessary around the car seat in order to move the side panels between their stored and deployed positions. An optional lateral crease across the top and side panels serves a similar function when folding the top back for access. The side and rear panels may be folded upward into positions substantially parallel to the top panel and releasably secured there to form a substantially flat package for storage of the sunshade.

### RELATED APPLICATIONS

This applications is related to and claims priority to U.S. patent application Ser. No. 10/246,500, filed Sep. 18, 2002, entitled “Folding Sunshade For Car Seat,” which has the same inventors, is commonly owned, and is incorporated herein in its entirety for all that it teaches.

### BACKGROUND

Several attempts have been made to develop an inexpensive sunshade for car seats, many using folded cardboard or other sheet material. While functional and inexpensive, these designs often suffer from problems with structural integrity, ease of access, or visibility. One example is disclosed in U.S. Pat. No. 4,784,433 to Purnell-Ayres. This example is a simple folding sunshade with rear, top and side panels made of rubber. A significant drawback in this sunshade is that there is no attachment between the side panels and the rear panel. The side panels are thus free to swing sideways and the top and sides are free to lift upward, especially in response to wind. This poses a risk to the infant since the sunshade could easily strike the infant in response to a gust of wind from an open window.

Another design is disclosed in U.S. Pat. No. 4,923,249 to Mattox. Here, the sunshade has only side and top panels and is secured by inserting the panels between the cushions of the car seat. This configuration appears to be reasonably secure, but offers no alternatives for increasing visibility, or reducing confinement, by opening or removing the side panel on the side where the sun is not shining. Further, the sunshade must be completely removed to place or remove the infant.

A third design is disclosed in U.S. Pat. No. 5,067,770 to Hassel. This example is a sunshade which appears to be quite strong, but offers limited protection from the sides, has no allowance for adjustability, and can only be moved out of the way by removing it from the car seat.

Many other designs may exist but all seem to suffer from one or more of the following problems: poor structural integrity or a physical hazard to the infant; interference with placing the infant in the car seat, and/or lack of adjustability that allows for protection from the sun while providing visibility. Increased visibility improves the experience for the infant, but also improves the ability of the caregiver to monitor the infant.

There is need for a sunshade which can be used with a wide variety of infant car seats, is inexpensive to manufacture, and solves the above problems. Specifically, it should move out of the way to provide access to the car seat and infant, adjust to provide protection where needed and visibility elsewhere, and be structurally sound in all configurations, with no loose elements which can strike the infant if windblown.

### SUMMARY

Embodiments of the present invention are generally directed to a folding sunshade constructed of corrugated plastic or similar sheet material. By releasably interconnecting the various panels, it supports multiple configurations and can be folded out of the way.

In further embodiments, the sunshade is made of a partially transparent or translucent material that allows the baby or mother to see through the sunshade but still blocks the sunlight. For example, the polycarbonate material used with sunglasses may function as the material for the sunshade. In one embodiment, the sunshade includes slots that allow an anchor tether to be connected through the sunshade to an anchor point in the car. The sunshade may also include tabs that have one or more portions that are flexible to allow the tabs to connect portions of the sunshade. Finally, the sunshade includes, in embodiments, a strap or other attaching device that allows the sunshade to be connected to a chair.

The advantages of such an apparatus are a sunshade which can be inexpensively manufactured as a single die cut sheet, is adaptable to a wide variety of car seats, can be configured in various combinations of protection and visibility, and easily moves out of the way to provide access to the infant and the car seat.

The above and other features and advantages will become clearer from the detailed description, presented below in conjunction with the accompanying drawings.

### BRIEF DESCRIPTION OF THE DRAWINGS

FIG. 1 is a perspective view of the inventive sunshade installed on a typical car seat.

FIG. 2 is a cross section through the inventive sunshade installed on a typical car seat.

FIG. 3 is a perspective view of the sunshade.

FIG. 3A is a detailed view of a portion of FIG. 3 with a section of the top panel cut away to show the interaction of the tab at the rear of the brace with the slot in the rear panel.

FIG. 4 is a top view of the sunshade.

FIG. 5 is a side view of the sunshade.

FIG. 6 is a front view of the sunshade.

FIG. 7 is a perspective view of the sunshade with one side panel folded up over the top.

FIG. 7A is a detailed view of a portion of FIG. 7 with hidden edges illustrated to better below the interrelationship of the elements.

FIG. 8 is a perspective view of the sunshade with both side panels folded up.

FIG. 9 is a perspective view of the sunshade with both side panels and the rear panel folded up over the top panel for storage.

FIG. 10 illustrates the sunshade flattened as it might be cut during manufacturing.

FIG. 11 illustrates an embodiments of a tab and slot that allows for coupling or connection of different portions of the sunshade.

FIG. 12 illustrates an embodiment of the sunshade with optional openings or slots that allow the connection of the Lower Anchors and Tethers for Children (LATCH) tether system to an anchor point in an automobile.

FIG. 13 illustrates an attaching member that allows the sunshade to be attached to a chair.

The disclosed invention is described below with reference to the accompanying figures in which like reference numbers designate like parts.

### DETAILED DESCRIPTION

This disclosure will now more fully describe some embodiments with reference to the accompanying drawings, in which only some of the possible embodiments are shown. Other aspects may, however, be embodied in many different forms and should not be construed as limited to the embodiments set forth herein. Rather, these embodiments are provided so that this disclosure will be thorough and complete and will fully convey the scope of the possible embodiments to those skilled in the art.

Glossary

The following is a brief glossary of terms used herein. The supplied definitions are applicable throughout this specification and the claims. It should be noted that there may be other meanings for the terms as used herein that are applicable to one or more embodiments. Those alternative definitions are also within the scope of the embodiments.

Car Seat—generally an infant seat of the type designed to be placed in the seat of a vehicle and retained in position by the use of the vehicles seat belts or other retaining mechanism. This term is intended to be broadly construed to include all similar seating devices whether or not for infants or for use in vehicles.

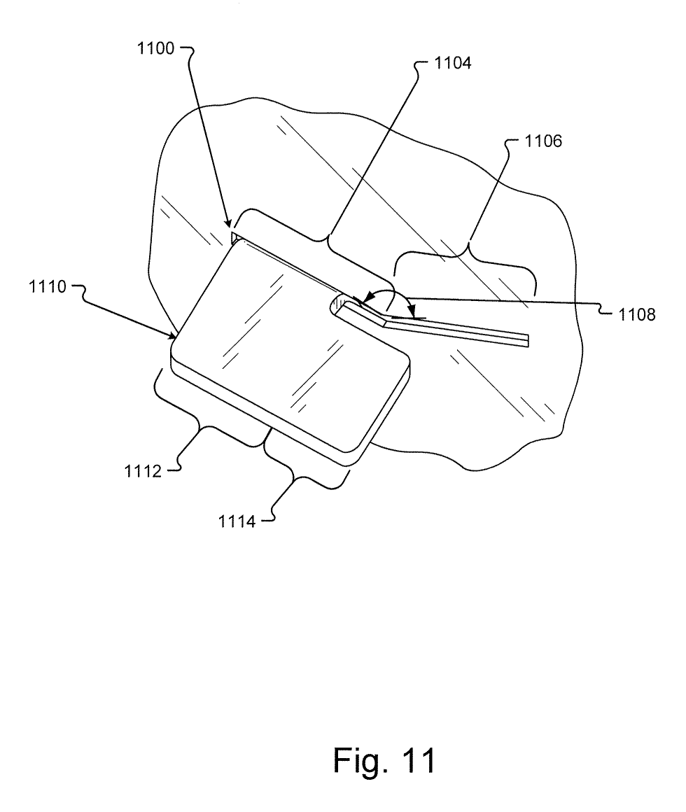

Slot—generally a narrow, elongated opening cut through a panel, intended to receive a tab or other member. In one embodiment, the slot has two or more portions or sections. An embodiment of the slot 1100 with two portions 1104 and 1106 is shown in FIG. 11. A first portion 1104 has a first predetermined length. A second section 1106 has a second predetermined length. The second section 1106 may be set at an angle 1108 to the first section 1106. In embodiments, the first or second predetermined lengths or the angle 1108 can be any length or angle. The angle 1108 of the slot allows a tab 1110, with a flexible portion 1114 to couple with the slot 1100 but straighten as to lock the tab 1110 into the slot 1100.

Tab—a member that may generally be an extension of a panel intended to be inserted into a slot for the purpose of retaining one or more panels in position. In embodiments, the tab has two sections 1112 and 1114 as shown in FIG. 11. A first section 1112 can releasably engage the first section 1104 of the slot 1100, as discussed above. The first section 1112, in embodiments, has a first predetermined length that is comparable to the associated first section 1104 of the slot 1100. A flexible tab end 1114 can form the second section 1114 of the tab 1110. The flexible tab end 1114 has a second predetermined length and can bend some degree. The length and the bend of the flexible tab end 1114 allow the flexible tab end 1114 to releasably engage the angled second section 1106 of the slot 1100, as discussed above. The flexible tab end 1114 can straighten after intersecting the slot 1100.

Overview

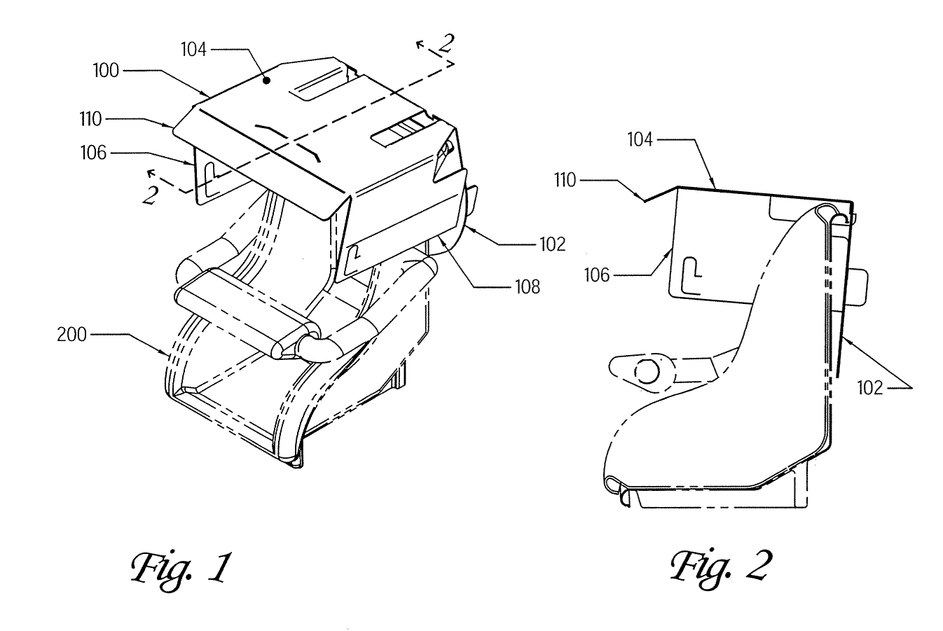

As can be seen in FIGS. 1 and 2, an embodiment of a sunshade 100 is adapted for use with an infant car seat 200 or similar seat. The sunshade is positioned with the back panel 102 extending downward behind the car seat, sandwiched between the car seat and the vehicle seat upon which the car seat has been placed. The clamping force provided by this arrangement is sufficient to hold the sunshade 100 in position. The top panel 104 extends forward over the car seat, and its occupant, to provide the majority of the shade. Side panels 106 and 108 extend downward from the sides of the top panel to provide increased coverage when desired. Front flap 110 angles downward from the front edge of the top panel 104 to provide increased coverage from the front of the sunshade 100.

The sunshade 100 offers significant flexibility in terms of configuration and adaptability. Further, dual functionality, as offered by the side panels 106 and 108 also serving as supports, provides increased strength without the need for additional components. Referring to FIG. 10 it can be seen that the design of the sunshade 00 also offers a simple, one-piece design, which can be inexpensively manufactured.

Throughout the following discussion and in the accompanying figures, the tabs and slots used to provide the various connections are shown in the orientations used in the exemplary embodiment. Clearly, the direction and orientation of these tabs and slots can be reversed or otherwise re-oriented unless explicitly stated otherwise. Generally, creases are used to provide a hinged connection between the various panels. In alternative embodiments, fabric connections or hinges could be used to provide the same flexible connection.

It should be noted that several of the slots, such as 134, 118, and 130 are formed with two distinct segments oriented at a slight angle relative to each other. This is done so that when the corresponding tabs, which are straight, are inserted through the slot, they will be bent and then spring back to straight on the far side of the panel. A relief cut in the base of the tabs allows side of the tab to overlap the panel, preventing the tab from being retracted without again bending the tab. This serves to retain the tab in position as it cannot be withdrawn by merely pulling on the part it is retaining.

Structure

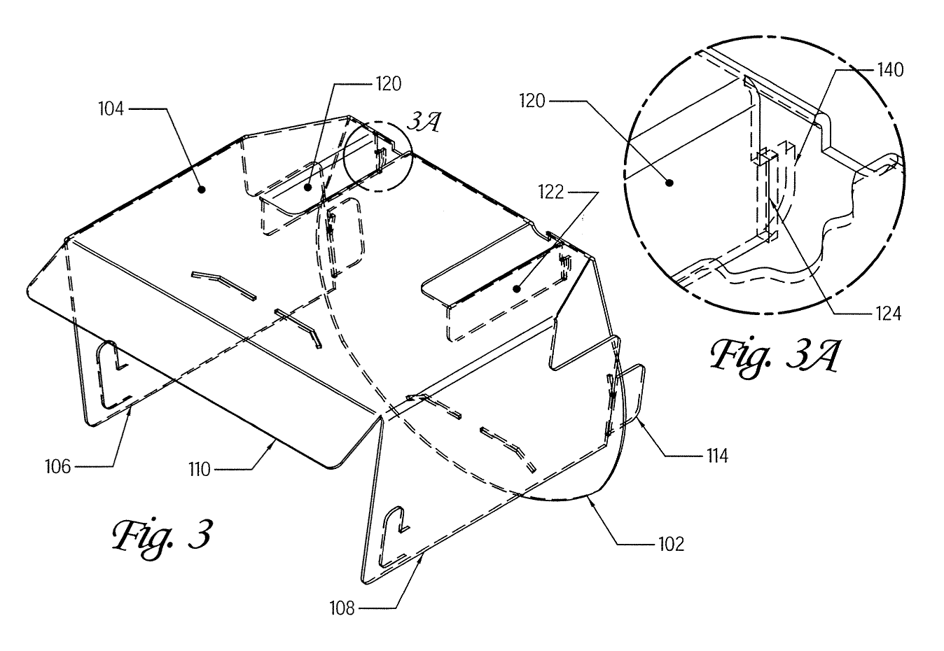

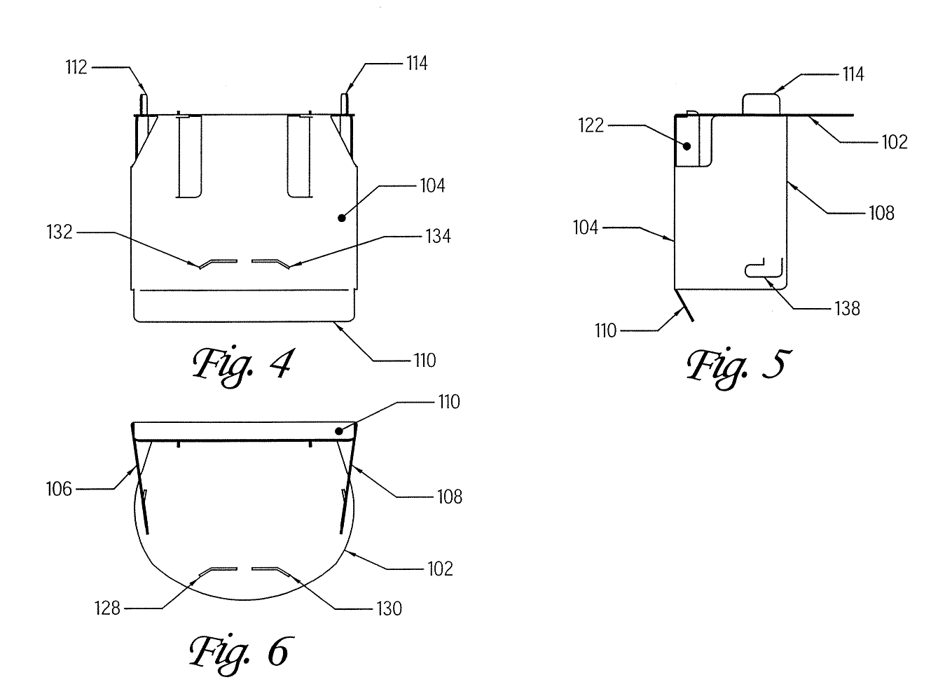

Referring to FIGS. 3-6, the sunshade 100 can be seen in its default configuration, with both side panels lowered. The individual elements may be more clearly understood by also referencing FIG. 10.

Top panel, 104, extends outward from the back panel, 102, in a position which is generally horizontal above the car seat. In one embodiment, the angle between the top panel 104 and the back panel 102 is substantially perpendicular, but this angle is not critical. Other angles could clearly be used and may be desirable to adapt the sunshade 100 to different car seats or other applications. The angle could even be made adjustable if desired. The angle of the top panel 102 to the car seat is dependent on several factors, including the angle of the rear of the car seat where it contacts the back panel 104.

The top panel 102 is held in position by a redundant set of supports. The primary support is provide by braces, 120 and 122, which fold downward, substantially perpendicular to the top panel, 104, and bear against the back panel, 102. The detailed view FIG. 3A illustrates brace, 120, bearing against the back panel and tab, 140, engaging slot, 124, to retain the brace in position. Brace, 122, is retained in a similar manner by a tab engaging slot 126. The secondary support for the top panel is provided by the side panels, 106 and 108, when folded down. In their “down” position, the side panels also bear against the back panel and are retained by tabs 112 and 114 fitting into slots 116 and 118 respectively. While the side panels are much larger than the braces, and provide significantly more support for the top panel when in their down position, they will not always be in this position. Either or both of the side panels may be folded upward as discussed below. In this situation, the braces provide sufficient support for the top panel that the shape of the sunshade is retained with any configuration of the side panels.

Front flap, 110, extends forward from the top panel and in the preferred embodiment is formed by creasing an extension of the top panel. This provides a certain amount of angular adjustment for the front flap at a minimal cost. If preferred some other mechanism, such as a metal, plastic, or fabric hinge could be used and a means for holding the flap at a particular angle could be provided.

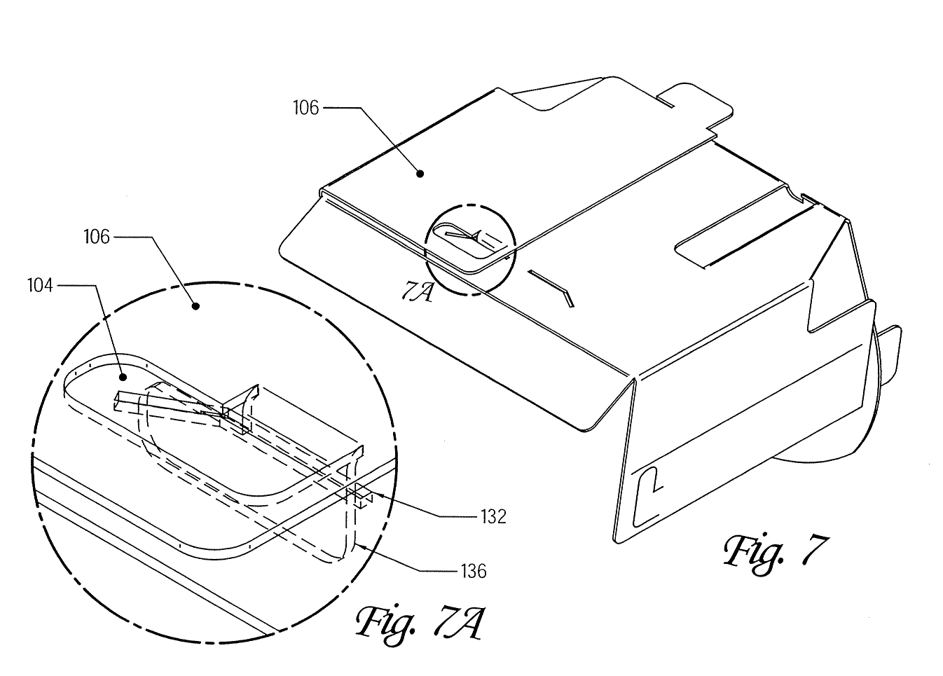

As illustrated in FIGS. 7 and 7A, either side panel can be folded up to provide increased visibility while still maximizing protection on the other side. This is especially beneficial where the sun may be shining through the side window of the car. The flap on that side can be left down for protection while the flap on the interior side is raised. As shown, the flap is secured in its raised position by inserting tab, 136, into slot, 132, in the top panel, 104. The other side panel would be secured in a similar manner using tab, 138, and slot, 134.

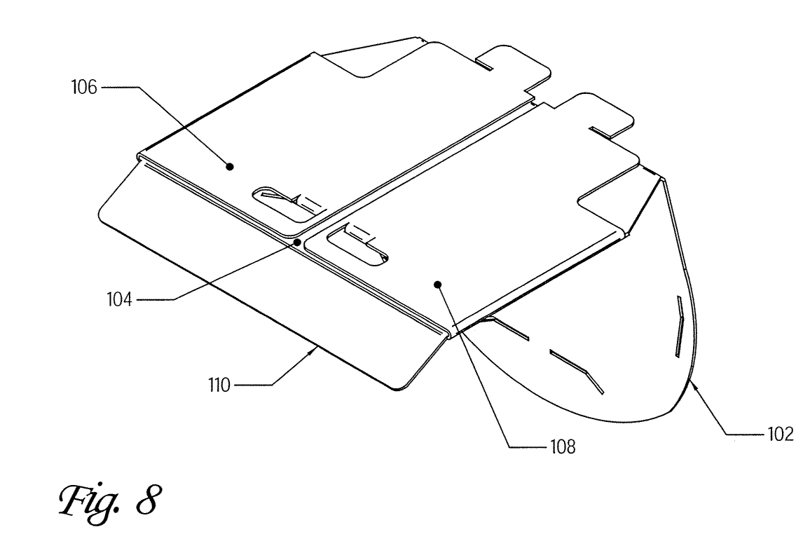

The user also has the option of folding up both side panels as illustrated in FIG. 8. This provides for maximum visibility for the infant and of the infant by the caregiver. As discussed above, the top flap is supported by the braces, 120 and 122, as shown in FIG. 3.

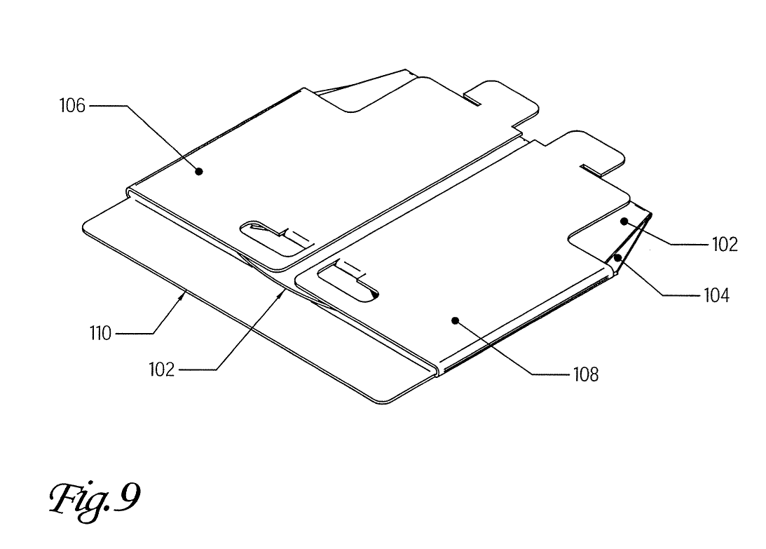

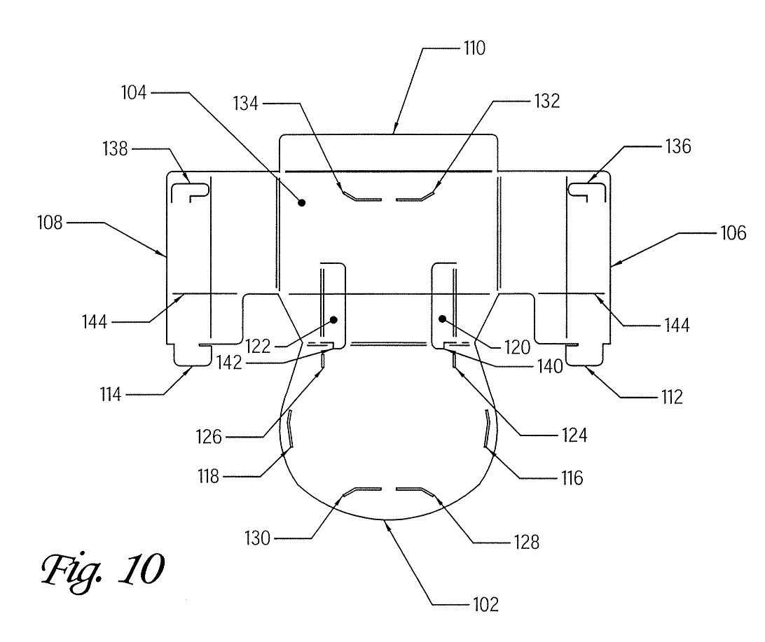

The design of the inventive sunshade also allows it to be folded into a compact package for storage, sale, or shipping. Referring to FIG. 9 the stored configuration can be seen. Rear panel, 102, has been folded up over the top panel, 104, and then the side panels, 106 and 108, have in turn been folded up and over the rear panel. Tab, 136, passes through slot, 128, in the rear panel and slot, 132, in the top panel. Likewise, tab, 138, passes through slot, 130, in the rear panel and slot, 134, in the top panel. This secures the panels in their stored position, maintaining a relatively flat package. If desired, the sunshade could be adapted to allow the front flap, 110, to also be folded under the side panels for storage. Alternatively, the rear panel could be folded against the lower surface of the top panel, opposite of the side panels, and secured by inserting the side panel tabs through the top panel and then the rear panel.

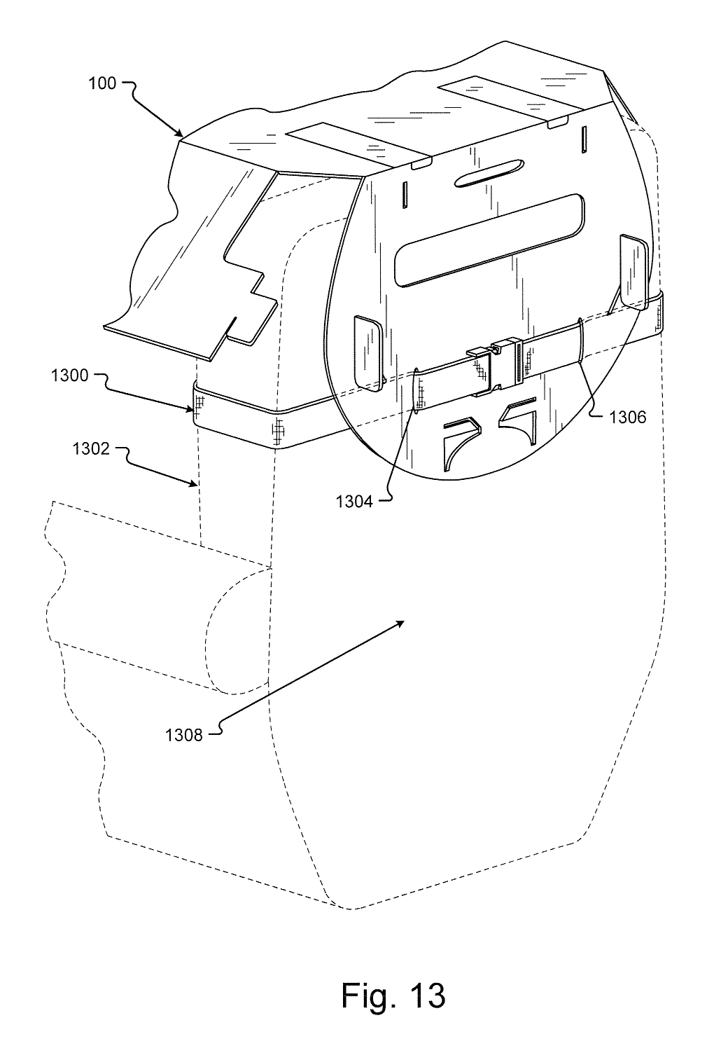

In another embodiment, an attaching member 1300 irremovably attaches the sunshade 100 to a chair 1302 or other furniture. The attaching member 1300 can be any device that affixes the sunshade 100 to the chair 1302. For example, a rope or strap, as shown in FIG. 13, can be woven or interlaced through two or more slots 1304 and 1306 on the sunshade 100, wrapped around the back 1308 of the chair 1302 and connected to hold the sunshade 100 against the chair 1302. In other embodiments, a cavity is formed, for example, from a second panel (not shown), and accepts the back of the chair. Other attaching members 1300 are possible as recognized by one skilled in the art.

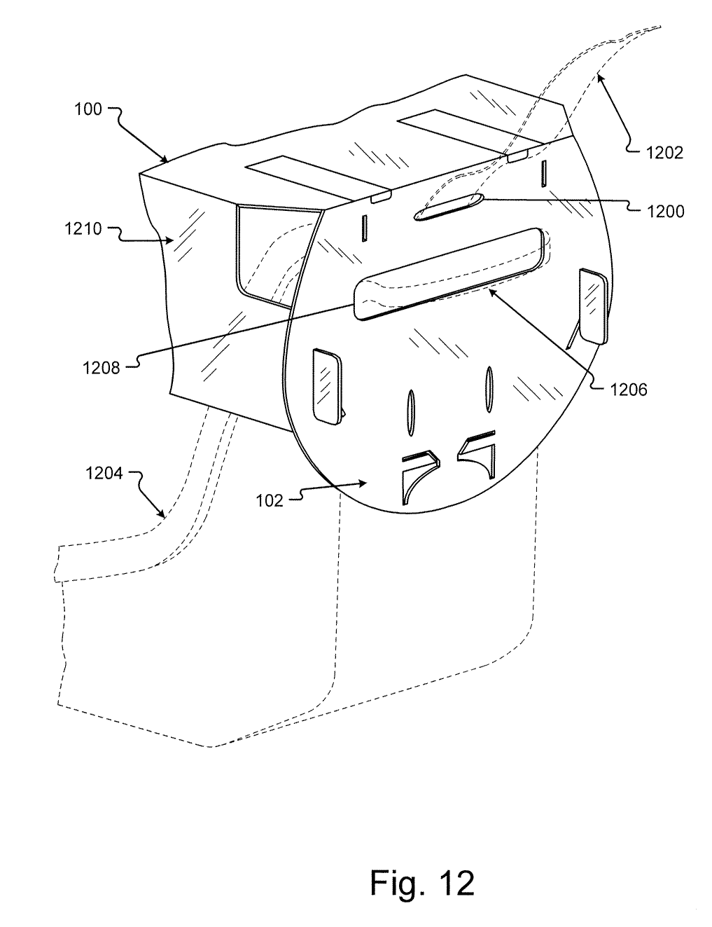

The sunshade 100, in embodiments, also includes one or more slots 1200 that allow a tether system 1202 for the child safety seat 1204 to intersect the sunshade 100 and couple with the anchor point in the car as shown in FIG. 12. The LATCH system mandated by the National Highway Transportation Safety Board requires a tether 1202 to anchor the top of child safety seats 1204. To allow the tether 1202 to anchor the child safety seat 1204, a slot 1200 or other opening is provided in the back panel 102 of the sunshade 100. The tether 1202 intersects the back panel 102 to mate with the anchor in the car.

Similar to the LATCH system, new safety guidelines require that the top edge 1206 of the child car seat 100 firmly contact the seat back of the car. As such, one embodiment provides a slot 1208 or other opening that allows the child safety seat 100 to intersect the back panel 102 of the sunshade 100 and contact the seat back of the car. The slot or opening 1208 may be of fixed size or have an opening that could be adjusted with flexible panels or a membrane or fabric that would overlap the back 1206 of the child safety seat 100.

Operation

To use the sunshade, rear panel, 102, is inserted behind the back of car seat, between it and the vehicle seat on which it is resting. Top panel, 104, is folded forward, over the car seat.

Braces, 120 and 122, are folded downward and secured by inserting tabs, 140 and 142, into slots, 124 and 126, respectively.

The user may then configure the sunshade for the level of protection and visibility desired by positioning the side panels. If folded down, tabs, 112 and 114, will be inserted in to slots, 116 and 118 respectively. If folded up, they will be secured by inserting tabs, 136 and 138, into slots 132 and 134 respectively. Front flap, 110, may also be adjusted by changing its angle.

It should be noted that securing the side panels in their down position by the use of tabs and slots as discussed above serves a dual purpose. First, it strengthens the sunshade by further bracing the top panel. The tabs allow the side panels to resist upward as well as downward movement of the top panel. Second, it holds the side panels in position. If unsecured, wind from an open car window could cause the side panels to flap, perhaps violently, possibly striking the infant in the car seat. With the tabs in place, this risk is avoided.

To simplify the task of placing the infant in the car seat or removing it from the car seat, the sunshade may be folded out of the way without removing it, tabs, 112 and 114, are released from their slots, if necessary, and the top panel folded backward, clear of the car seat. In the preferred embodiment, tabs, 140 and 142, in the braces do not lock into their tabs, allowing the top panel to be lifted, or folded back, without the need to release these tabs. Clearly these tabs could be made locking if desired. An optional lateral crease, 144 in FIG. 10, allows the top and side panels to bend while the sunshade is being folded back to provided increased clearance to the ceiling of the vehicle.

While tabs and slots have been used in the preferred embodiment to interconnect the panels, other methods could clearly be used. An obvious choice is hook and loop fastener affixed to the panels in mating locations. This offers advantages in simplicity but is more expensive and doesn't readily allow for multiple panels to be joined with a single connector.

The hook and loop fastener can also be used in combination with the tabs and slots to provide more secure attachment than either alone. This may be done by using the hook and loop fastener to hold the same panel as the tabs, in a redundant approach, or by using the hook and loop fastener to hold the tabs in position within the slot such as by attaching the tab to the surface on the far side of the panel through which it extends when mated with the slot.

Materials

A variety of sheet materials are applicable for use in the present invention. Corrugated paperboard is functional but has been found to fatigue rapidly. Corrugated plastic has been found to perform well, offering light weight, good rigidity, and increased resistance to fatigue and tearing at the creases as exhibited by paper based materials. In other embodiments, the sheet material is semi-transparent, as represented by the shading 1210 of the sunshade 100 shown in FIG. 12. For example, some amount of light passes through the sheet material allowing the baby to see through the panels, the caregiver can see the baby through the panels, but some amount of sunlight is filtered by the semi-transparent material. The amount of light to pass through the semi-transparent material depends on the material used, the thickness of the material, and the construction of the material, for example, polarized materials. In further embodiments, the semi-transparent material is a plastic, high index plastic, or a poly carbonate material similar to materials used in sunglass lenses.

While the preferred form of the invention has been disclosed above, alternative methods of practicing the invention are readily apparent to the skilled practitioner. The above description of the preferred embodiment is intended to be illustrative only and not to limit the scope of the invention.

What is claimed is:

1. A sunshade for use with a car seat, the sunshade comprising:
a rear panel adapted to be inserted behind the car seat;
a top panel having a flexible connection to the rear panel and adapted to extend forward over the car seat;
at least one brace, bearing upon the rear panel and supporting the top panel; and
opposing side panels flexibly connected to the top panel and adapted to extend downward, the side panels individually movable from a downward deployed position to an upward stored position, the side panels releasably attached to the rear panel when in the deployed position, the side panels bear against the rear panel when in the deployed position thereby further supporting the top panel and the brace, and the side panels releasable from the rear panel and the top panel, the side panels and the brace foldable upward and rearward as a unit;
wherein at least one of the side panels or the top panel is made from a semi-transparent material.

2. The sunshade as defined in claim 1, wherein the side panels are releasably attached to the rear panel with a tab and associated slot.

3. The sunshade as defined in claim 2, wherein the associated slot comprises:
a first section of first predetermined length;
a second section of second predetermined length set at an angle to the first section

4. The sunshade as defined in claim 3, wherein the tab comprises:
a first section of predetermined length that releasably engages the first section of the slot;
a flexible tab end, the flexible tab end bending some degree to releasably engage the second section of the slot.

5. The sunshade as defined in claim 1, wherein the semi-transparent material is one of polycarbonate, plastic, or high index plastic.

6. The sunshade as defined in claim 1, further comprising an attaching member operable to irremovably attach the sunshade to a chair.

7. The sunshade as defined in claim 1, further comprising a slot inset into the rear panel, the slot allowing an anchor member for the car seat to intersect the rear panel and attach to the anchor point in a car.

8. The sunshade as defined in claim 1, further comprising a car seat slot inset into the rear panel, the car seat slot allowing a top of the car seat to intersect the rear panel and abut a seat in a car.

9. The sunshade as defined in claim 1, wherein the top panel includes one or more creases allowing the top panel to fold back over the rear panel.

10. A sunshade for use with a chair, the sunshade comprising:
a rear panel adapted to be inserted behind the chair;
a top panel having a flexible connection to the rear panel and adapted to extend forward over the car seat;
opposing side panels flexibly connected to the top panel, individually movable from a downward deployed position to an upward stored position substantially parallel to the top panel;
plural braces, flexibly connected to the top panel and bearing upon and releasably attachable to the rear panel, wherein the side panels bear against and releasably attaches to the rear panel when in the deployed position, and wherein the braces and the side panels are releasable from the rear panel and the top panel, the side panels and the brace foldable upward and rearward as a unit; and
an attaching member irremovably attaching the sunshade to the chair.

11. The sunshade as defined in claim 1, wherein the side panels are releasably attached to the rear panel with a tab and associated slot.

12. The sunshade as defined in claim 2, wherein the associated slot comprises:
a first section of predetermined length;
a second section of predetermined length set at an angle to the first section

13. The sunshade as defined in claim 3, wherein the tab comprises:
a first section of predetermined length that releasably engages the first section of the slot;
a flexible tab end, the flexible tab end bending some degree to releasably engage the second section of the slot.

14. The sunshade as defined in claim 1, wherein at least a portion of the sunshade is made from one of a sandwich construct, polycarbonate, plastic, or high index plastic.

15. The sunshade as defined in claim 1, wherein the top panel includes one or more creases allowing the top panel to fold back over the rear panel.

16. A sunshade for use with a car seat, the sunshade comprising:
a rear panel adapted to be inserted behind the car seat;
a top panel having a flexible connection to the rear panel and adapted to extend forward over the car seat;
opposing side panels flexibly connected to the top panel, individually movable from a downward deployed position to an upward stored position substantially parallel to the top panel;
plural braces, flexibly connected to the top panel and bearing upon and releasably attachable to the rear panel,
wherein the rear panel is movable to a stored position substantially parallel to the top panel and is secured in the stored position by the side panels wherein in their the stored position and further comprising a single means for releasably attaching each of the side panels to the top panel when the side panels are in the stored position and wherein each of the means for releasably attaching also releasably attaches the rear panel to the top panel when the rear panel is in the stored position; and
a slot inset into the rear panel, the slot allowing an anchor member for the car seat to intersect the rear panel and attach to the anchor point in a car.

17. The sunshade as defined in claim 1, wherein the side panels are releasably attached to the rear panel with a tab and associated slot.

18. The sunshade as defined in claim 2, wherein the associated slot comprises:
a first section of predetermined length;
a second section of predetermined length set at an angle to the first section

19. The sunshade as defined in claim 3, wherein the tab comprises:
a first section of predetermined length that releasably engages the first section of the slot;
a flexible tab end, the flexible tab end bending some degree to releasably engage the second section of the slot.

20. The sunshade as defined in claim 1, wherein at least a portion of the sunshade is made from one of a sandwich construct, polycarbonate, plastic, or high index plastic.
